(19) United States
(12) Patent Application Publication
(10) Pub. No.: US 2016/0299414 A1
(43) Pub. Date: Oct. 13, 2016

(54) PROJECTOR

(71) Applicant: Seiko Epson Corporation, Tokyo (JP)

(72) Inventors: Kazuya Usuda, Matsumoto-shi (JP); Kaname Nagatani, Matsumoto-shi (JP); Kentaro Nakamura, Shiojiri-shi (JP)

(21) Appl. No.: 15/092,542

(22) Filed: Apr. 6, 2016

(30) Foreign Application Priority Data
Apr. 8, 2015 (JP) 2015-079014

(51) Int. Cl. G03B 21/16; G02B 27/00; G03B 21/14

(52) U.S. Cl. CPC G03B 21/16; G03B 21/145; G02B 27/0006

(57) ABSTRACT

A projector includes a cooling device configured to cool an electrooptical device serving as a cooling target. The cooling device includes a closed housing in which the electrooptical device is disposed and a circulation channel for circulating cooling air is formed, a circulation fan configured to circulate the cooling air in the closed housing, and a heat absorber disposed on the circulation channel and configured to absorb heat of the cooling air in the closed housing. The closed housing includes, on the inner side, an inner wall section that forms the circulation channel having an annular shape. The heat absorber is disposed on the opposite side of the electrooptical device across the inner wall section.

### BACKGROUND

1. Technical Field

The present invention relates to a projector.

2. Related Art

There has been known a projector including a light source device, an electrooptical device including a light modulating device such as a liquid crystal panel that modulates, according to image information, a light beam emitted from the light source device and forms image light, and a projection lens (a projection optical device) that expands and projects the image light.

In such a projector, in order to effectively cool the light modulating device, there has been proposed a configuration including a closed structure in which the electrooptical device is disposed, a circulation fan disposed in the closed structure to circulate the air, and a cooling device that cools the air in a closed space (see, for example, JP-A-2000-298311 (Patent Literature 1).

In the projector described in Patent Literature 1, the cooling device includes a first heat transfer member, a thermoelectric conversion element (a Peltier element), and a second heat transfer member. The first heat transfer member is disposed inside the closed structure. The first heat transfer member absorbs heat from the air inside the closed structure to cool the air. The thermoelectric conversion element is connected to the respective first and second heat transfer members. The thermoelectric conversion element transfers the heat of the first heat transfer member to the second heat transfer member with electric power supplied to the thermoelectric conversion element. The second heat transfer member is disposed outside the closed space. The second heat transfer member radiates the heat transferred from the first heat transfer member via the thermoelectric conversion element. The air in the closed space is cooled by the cooling device and the air is circulated by the circulation fan, whereby the electrooptical device, which is a cooling target, is cooled.

Incidentally, in the case of the configuration for cooling the air on the inside by cooling the transfer members disposed inside the closed structure in this way, dew condensation is likely to occur in the heat transfer member depending on the environmental temperature and the temperature and the humidity in the closed space. In such a case, water drops caused on the surfaces of the heat transfer members by the dew condensation are likely to, for example, scatter inside a closed container to adhere to the electrooptical device.

### SUMMARY

An advantage of some aspects of the invention is to provide a projector that can suppress the influence of dew condensation.

A projector according to an aspect of the invention includes a cooling device configured to cool a cooling target. The cooling device includes: a closed housing in which the cooling target is disposed and a circulation channel for circulating cooling air is formed; a circulation fan configured to circulate the cooling air in the closed housing; and a heat absorber disposed on the circulation channel and configured to absorb heat of the cooling air in the closed housing. The closed housing includes, on the inner side, an inner wall section that forms the circulation channel having an annular shape. The heat absorber is disposed on the opposite side of the cooling target across the inner wall section.

According to the aspect, the cooling target and the heat absorber are disposed on the opposite sides across the inner wall section of the closed housing. Consequently, even if water drops due to dew condensation in the heat absorber scatter, it is possible to block the water drops with the inner wall section before the water drops adhere to the cooling target. Therefore, since it is possible to suppress the water drops due to the dew condensation in the heat absorber from scattering and adhering to the cooling target, it is possible to suppress the influence of the dew condensation on the cooling target and the projector.

In the aspect, it is preferable that the heat absorber is disposed on a channel of the cooling air circulating in a direction opposite to one direction, which is a circulating direction of the cooling air circulating to the cooling target in the circulation channel.

According to the aspect with this configuration, the cooling target and the heat absorber are disposed in positions where the circulating direction of the cooling air is the opposite directions in the circulation channel. Consequently, in the circulation channel, it is possible to surely dispose the cooling target and the heat absorber on opposite sides each other. It is possible to dispose the cooling target and the heat absorber apart from each other. Therefore, even if the water drops are caused, it is possible to more surely suppress the water drops from adhering to the cooling target.

In the aspect, it is preferable that the cooling device includes a cooling fan and an air guide duct configured to circulate the cooling air in the closed housing to the cooling target, the cooling fan delivers the cooling air in the one direction via the air guide duct, and the circulation fan delivers the cooling air in the opposite direction.

According to the aspect with this configuration, the cooling target is located on the channel in which the cooling air circulates in the one direction. Therefore, the cooling fan can surely circulate the cooling air to the cooling target by delivering the cooling air in the one direction via the air guide duct. The circulation fan delivers the cooling air in the opposite direction. Therefore, the circulation fan is located on the channel in which the cooling air circulates in the other direction. Consequently, even if dew condensation occurs in the heat absorber and water drops scatter, it is possible to suppress, with the circulation fan, the water drops from further scattering.

In the aspect, it is preferable that the projector further includes an exterior housing configuring an exterior, and respective rotation axes of the cooling fan and the circulation fan are substantially orthogonal to the bottom surface of the exterior housing.

For example, when, to set the rotation axes to extend along a direction crossing the one direction and the opposite direction, the cooling fan and the circulation fan are disposed on a channel in which the cooling air circulates in the crossing direction, the dimensions of the closed housing in directions orthogonal to the bottom surface (i.e., the one direction and the opposite direction) increase according to the dimensions of the fans.

On the other hand, according to the aspect with this configuration, to set the rotation axes to be substantially orthogonal to the bottom surface, the cooling fan and the circulation fan are respectively disposed in positions where the cooling air is respectively delivered in the one direction and the opposite direction. Consequently, it is possible to reduce the dimensions of the closed housing in the directions orthogonal to the bottom surface. It is possible to achieve a reduction in the thickness of the projector.

In the aspect, it is preferable that the cooling air circulates in the order of the heat absorber, the circulation fan, the cooling fan, and the cooling target.

According to the aspect with this configuration, it is possible to circulate, with the circulation fan, the cooling air delivered to the cooling target by the cooling fan and heated and guide the cooling air to the heat absorber. It is possible to circulate the cooling air having low temperature to the cooling target. Therefore, it is possible to appropriately cool the cooling target.

When dew condensation occurs in the heat absorber, even if water drops are scattered by the cooling air, since the circulation fan and the cooling fan are located between the heat absorber and the cooling target, it is possible to stop the water drops in the fans.

In the aspect, it is preferable that the projector further includes an exterior housing configuring an exterior, the cooling target and the heat absorber are disposed apart from each other in the horizontal direction when the projector is set in a first posture in which the bottom surface of the exterior housing is substantially horizontal, and the heat absorber is located below the cooling target when the projector is set in a second posture in which one side surface of the exterior housing faces vertically downward.

According to the aspect with this configuration, when the projector is set in the first posture, since the cooling target and the heat absorber are apart from each other in the horizontal direction, even if dew condensation occurs in the heat absorber, it is possible to suppress water drops from adhering to the cooling target. On the other hand, when the projector is set in the second posture, since the heat absorber is located below the cooling target, it is possible to prevent the water drops from adhering to the cooling target. Therefore, irrespective of in which of the first posture and the second posture the projector is set, it is possible to suppress the influence of the dew condensation.

In the aspect, it is preferable that, when the posture of the projector is changed from the first posture to a third posture in which the rear surface of the exterior housing faces vertically downward or a fourth posture in which the rear surface faces vertically upward, the cooling target and the heat absorber are always disposed apart from each other in the horizontal direction during a process of the posture change.

According to the aspect with this configuration, in the projector, in the process of changing the posture of the projector from the first posture to the third posture or the fourth posture, the cooling target and the heat absorber are disposed apart from each other in the horizontal direction. In such a configuration, it is possible to suppress water drops from dropping from the heat absorber and adhering to the cooling target during the posture change and after the posture change. It is possible to suppress occurrence of a deficiency due to the adhesion of the water drops.

Note that the rear surface in the projector is, for example, a surface located on the opposite side of a projecting direction in which an image is projected. In this case, the third posture is a posture in which the image is projected vertically upward (an upward projection posture) and the fourth posture is a posture in which the image is projected vertically downward (a downward projection posture).

### BRIEF DESCRIPTION OF THE DRAWINGS

The invention will be described with reference to the accompanying drawings, wherein like numbers reference like elements.

FIG. 1 is a perspective view showing a projector in an embodiment of the invention.

FIG. 2 is a schematic diagram showing the internal configuration of the projector in the embodiment.

FIG. 3 is a block diagram showing the configuration of a cooling device in the embodiment.

FIG. 4 is a schematic diagram showing the configuration of the cooling device in the embodiment.

### DESCRIPTION OF EXEMPLARY EMBODIMENTS

An embodiment of the invention is explained below with reference to the drawings.

### Schematic Configuration of a Projector

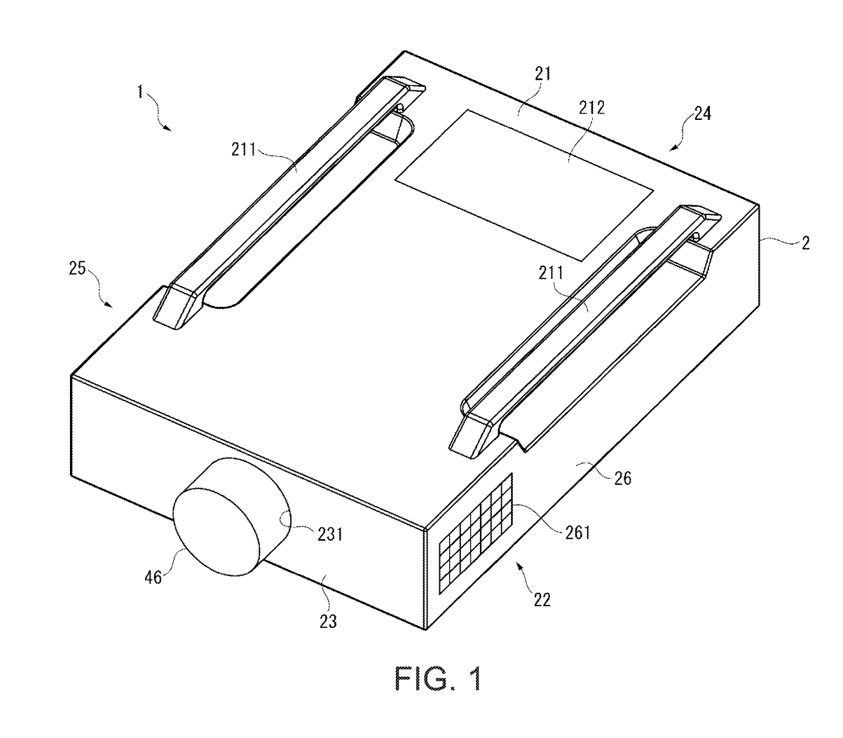

FIG. 1 is a perspective view showing the exterior configuration of a projector 1 according to this embodiment.

The projector 1 modulates a light beam emitted from a light source, forms image light corresponding to image information, and enlarges and projects the formed image light on a projection surface (not shown in the figure) such as a screen. As shown in FIG. 1, the projector 1 includes an exterior housing 2 configuring an exterior.

### Configuration of the Exterior Housing

The exterior housing 2 includes a top surface section 21, a bottom surface section 22, a front surface section 23, a rear surface section 24, a left side surface section 25, and a right side surface section 26.

In the exterior housing 2, in the top surface section 21, grips 211 gripped by a user in carrying the projector 1 and connected to a fixing tool in fixing the projector to a ceiling or the like are provided. Besides, in the top surface section 21, an opening (not shown in the figure) for replacing alight source device 41 explained below is formed. The opening is covered by a cover member 212.

In the front surface section 23, an opening 231 from which a part of a projection optical device 46 explained below is exposed is formed.

In the right side surface section 26, an air intake port 261 rectangular in plan view is formed. In the exterior housing 2, although not shown in the figure, an exhaust port for discharging the air, which has cooled the components in the exterior housing 2, to the outside is formed in the left side surface section 25.

Note that a posture in which the projector 1 is disposed to direct the bottom surface section 22 vertically downward and image light is projected in the horizontal direction is referred to as normal setting posture (first posture). A posture in which the projector 1 is disposed to direct the right side surface section 26 vertically downward and image light is projected in the horizontal direction is referred to as lateral setting posture (second posture). The bottom surface section 22 is equivalent to the bottom surface according to the invention, the rear surface section 24 is equivalent to the rear surface according to the invention, and the right side surface section 26 is equivalent to the one side surface according to the invention.

The projector 1 can take, from the normal setting posture, an upward projection posture (a third posture) in which the projector 1 is disposed to direct the rear surface section 24 vertically downward and a downward projection posture (a fourth posture) in which the projector 1 is disposed to direct the rear surface section 24 vertically upward.

### Configuration of an Apparatus Main Body

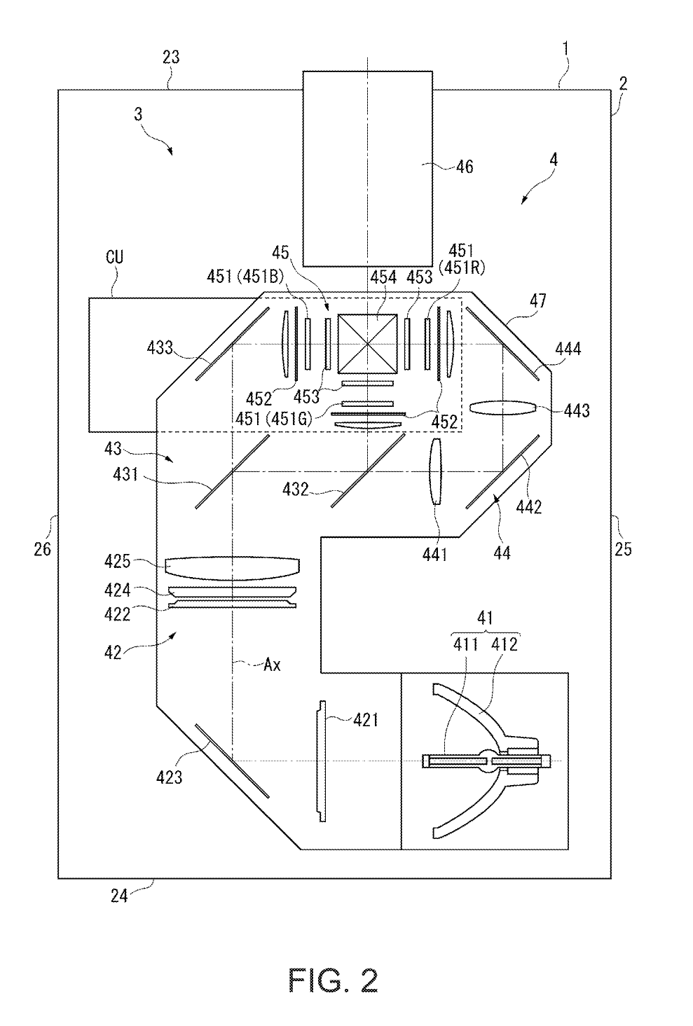

FIG. 2 is a schematic diagram showing the internal configuration of the projector 1.

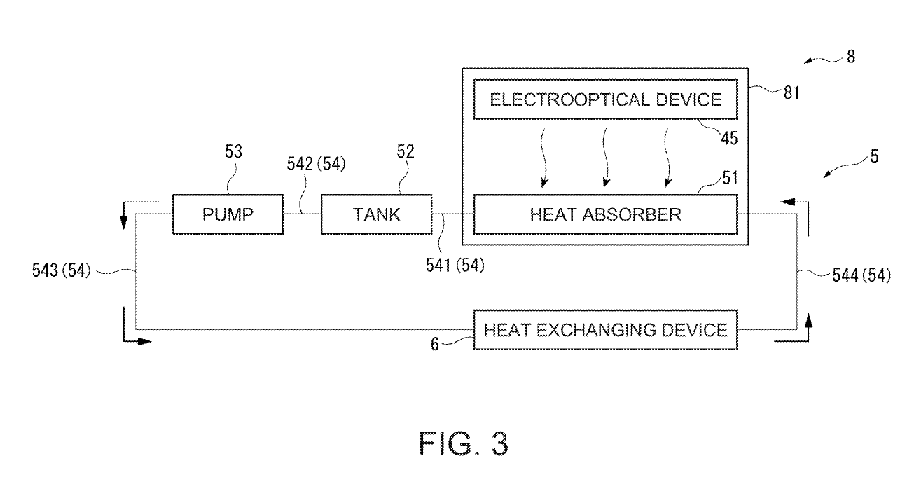

The projector 1 includes, besides the exterior housing 2, an apparatus main body 3 disposed in the exterior housing 2. As shown in FIG. 2, the apparatus main body 3 includes an optical unit 4 and includes a cooling device (CU) (see FIG. 3) explained below.

Note that, although not specifically shown in the figure, in the exterior housing 2, in spaces other than members 4 to 7, a power supply unit that supplies electric power to constituent members of the projector 1, a control device that controls the operations of the constituent members of the projector 1, and the like are disposed.

### Configuration of the Optical Unit

The optical unit 4 forms and projects image light corresponding to image information under the control by the control device. The optical unit 4 includes a light source device 41, an equalizing device 42, a color separation device 43, a relay device 44, an electrooptical device 45, a projection optical device 46, and a housing for optical components 47.

As the light source device 41, besides a light source device including a light source lamp 411 and a reflector 412, light source devices including solid-state light sources such as an LED (Light Emitting Diode) and an LD (Laser Diode) can be adopted.

The equalizing device 42 equalizes illuminance in a surface orthogonal to the center axis of light emitted from the light source device 41. The equalizing device 42 includes lens arrays 421 and 422, a reflection mirror 423, a polarization converting element 424, and a superimposing lens 425.

The color separation device 43 separates color lights of red, green, and blue from incident light. The color separation device 43 includes dichroic mirrors 431 and 432 and a reflection mirror 433.

The relay device 44 guides the red light among the three color lights separated by the color separation device 43 to a liquid crystal panel 451R of the electrooptical device 45. The relay device 44 includes an incident side lens 441, a relay lens 443, and reflection mirrors 442 and 444.

The electrooptical device 45 modulates the respective color lights of red, green, and blue and thereafter combines the color lights. The electrooptical device 45 includes three incident-side polarizing plates 452, three liquid crystal panels 451 (liquid crystal panels for the color lights of red, green, and blue are respectively represented as 451R, 451G, and 451B) functioning as light modulating devices, three emission-side polarizing plates 453, and a color combining device 454 that combines the color lights modulated by the liquid crystal panels 451.

The projection optical device 46 is a projection lens that projects image light combined by the color combining device 454 to the projection surface. The projection optical device 46 is disposed on the front surface section 23 side. Apart of the projection optical device 46 is exposed from the opening 231. The projection optical device 46 emits image light in a direction from the rear surface section 24 to the front surface section 23 (a projecting direction) and projects the image light on the projection surface.

The housing for optical components 47 houses the light source device 41, the equalizing device 42, the color separation device 43, and the relay device 44 on the inside. The housing for optical components 47 includes a component housing member in which a groove section (not shown in the figure) for housing various optical components is formed and a lid-like member that closes an opening for component housing formed in the component housing member. The component housing member and the lid-like member are formed of synthetic resin or metal. In the housing for optical components 47, the devices 41 to 44 are disposed in predetermined positions with respect to an illumination optical axis Ax set on the inside. The electrooptical device 45 is disposed on the illumination optical axis Ax.

### Configuration of the Cooling Device

FIG. 3 is a block diagram showing the schematic configuration of the cooling device CU.

The cooling device CU absorbs, from cooling air that has cooled the electrooptical device 45, heat generated from the electrooptical device 45 serving as a cooling target and radiates the absorbed heat to thereby cool the electrooptical device 45. The cooling device CU includes, as shown in FIG. 3, a circulating and cooling device 8, a heat absorbing device 5, a heat exchanging device 6.

Among the devices, the circulating and cooling device 8 includes a closed housing 81 in which the electrooptical device 45, which is the cooling target, is disposed. The circulating and cooling device 8 cools the electrooptical device 45. The configuration of the circulating and cooling device 8 and the disposition of configurations in the closed housing 81 are explained in detail below.

### Configuration of the Heat Absorbing Device

The heat absorbing device 5 absorbs heat from the air circulating in the closed housing 81 and transfers the heat to the heat exchanging device 6. The heat absorbing device 5 includes a heat absorber 51, a tank 52, a pump 53, and circulation pipes 54 (541 to 544) that connect the heat absorber 51, the tank 52, the pump 53 and in which cooling liquid circulates.

The heat absorber 51 is disposed in the closed housing 81. The heat absorber 51 absorbs heat from the cooling air circulating in the closed housing 81. The heat absorber 51 is connected to the tank 52 via the circulation pipe 541 and connected to the heat exchanging device 6 via the circulation pipe 544.

The tank 52 temporarily stores the cooling liquid circulating in the circulation pipe 54. The tank 52 is connected to the pump 53 via the circulation pipe 542.

The pump 53 pumps the cooling liquid, which flows into the pump 53 via the circulation pipe 542, to the circulation pipe 543 connected to the heat exchanging device 6.

The cooling liquid circulating to the heat exchanging device 6 is cooled by the heat exchanging device 6. The cooling liquid circulates to the heat absorber 51 via the circulation pipe 544. Consequently, the cooling liquid having low temperature circulates to the heat absorber 51. The cooling liquid having heat absorbed from the cooling air in the closed housing 81 by the heat absorber 51 is fed into the tank 52 from the heat absorber 51 via the circulation pipe 541. In this way, in the heat absorbing device 5, the cooling liquid is circulated by the driving of the pump 53.

### Configuration of the Heat Exchanging Device

The heat exchanging device 6 absorbs heat from the cooling liquid fed via the circulation pipe 543 of the heat absorbing device 5 and cools the cooling liquid. The heat exchanging device 6 transfers or radiates the absorbed heat to the outside of a circulation system including the heat absorbing device 5 and the circulating and cooling device 8.

### Configuration of the Circulating and Cooling Device

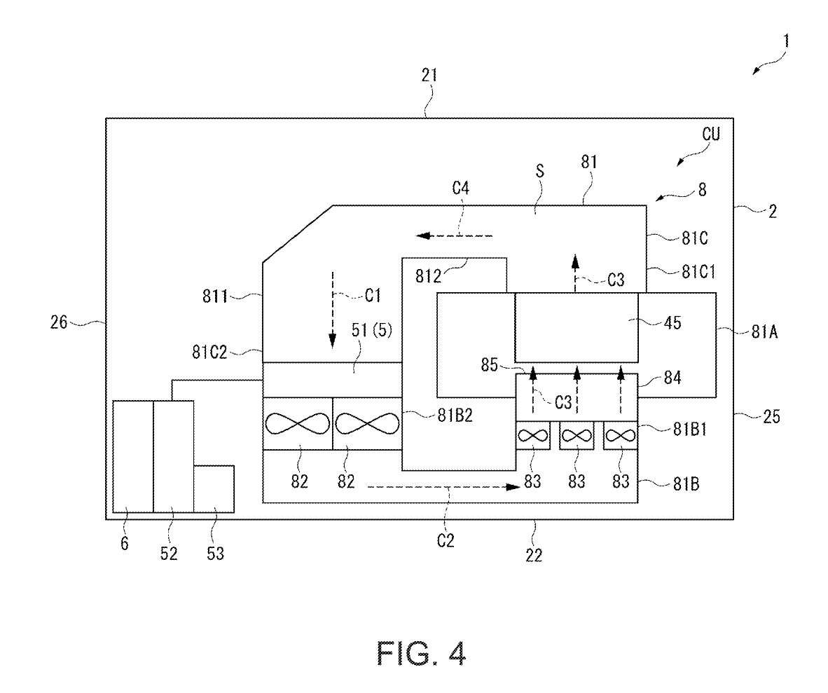

FIG. 4 is a schematic diagram showing the configuration and the disposition of the circulating and cooling device 8.

The circulating and cooling device 8 circulates the cooling air cooled by the heat absorbing device 5 to the electrooptical device 45 serving as the cooling target disposed in the closed housing 81 and cools the electrooptical device 45. The circulating and cooling device 8 includes, besides the closed housing 81, as shown in FIG. 4, circulation fans 82, cooling fans 83, an air guide duct 84, and a partition wall 85.

The closed housing 81 is a box-type housing that stores the electrooptical device 45, the circulation fans 82, the cooling fans 83, and the air guide duct 84 on the inside. The closed housing 81 is configured as a closed structure into which the air outside the closed housing 81 less easily flows in the exterior housing 2.

The closed housing 81 is configured by combining a connecting section 81A, a lower duct 81B, and an upper duct 81C.

The connecting section 81A is a part that connects an end portion 81B1 of the lower duct 81B and an end portion 81C1 of the upper duct 81C and is a part in which the electrooptical device 45 is disposed. The connecting section 81A is formed in substantially a cylindrical shape.

The lower duct 81B is formed in a U shape in longitudinal sectional view. When the projector 1 is set in the normal setting posture, the lower duct 81B is disposed below the electrooptical device 45. The cooling air circulates toward the electrooptical device 45 in the lower duct 81B.

The upper duct 81C is formed in a reverse U shape in longitudinal sectional view. When the projector 1 is set in the normal setting posture, the upper duct 81C is disposed above the electrooptical device 45. The cooling air, which has cooled the electrooptical device 45, is introduced into the upper duct 81C.

The heat absorber 51 of the heat absorbing device 5 is disposed between an end portion 81B2 on the opposite side of the end portion 81B1 in the lower duct 81B and an end portion 81C2 on the opposite side of the end portion 81C1 in the upper duct 81C.

The closed housing 81 includes an outer wall section 811 substantially rectangular in sectional view forming the outer edge of the closed housing 81 and an inner wall section 812 substantially rectangular in longitudinal sectional view located on the inner side of the closed housing 81. The closed housing 81 is formed by the outer wall section 811 and the inner wall section 812 like a duct in which the air circulates in an annular shape.

In a closed space S in the closed housing 81, the air in the closed housing 81 is circulated in order along a first direction C1, a second direction C2, a third direction C3, and a fourth direction C4 by the circulation fans 82 explained below. Note that the first direction C1 (equivalent to the opposite direction according to the invention) and the third direction C3 (equivalent to the one direction according to the invention) are opposite directions each other. The second direction C2 and the fourth direction C4 are opposite directions each other. The first direction C1 and the second direction C2 are substantially orthogonal to each other. The third direction C3 and the fourth direction C4 are substantially orthogonal to each other. Specifically, the first direction C1 is a direction from the top surface section 21 toward the bottom surface section 22. The third direction C3 is a direction from the bottom surface section 22 toward the top surface section 21. The second direction C2 and the fourth direction C4 are respectively directions included in surface substantially parallel to the top surface section 21 and the bottom surface section 22 and are opposite directions each other.

The circulation fans 82 are configured by axial fans. In this embodiment, two circulation fans 82 are provided. When the projector 1 is set in the normal setting posture, the circulation fans 82 are respectively located below the heat absorber 51 in the lower duct 81B. Specifically, to set rotation axes of the circulation fans 82, that is, a delivering direction of the cooling air along the first direction C1, the circulation fans 82 are disposed in positions where the cooling air circulates in the first direction C1. In other words, the circulation fans 82 are disposed to set the rotation axes of the fans substantially orthogonal to the bottom surface section 22 of the exterior housing 2. When the circulation fans 82 are driven by the control device, the air in the closed housing 81 circulates as explained above.

Note that the circulation fans 82 desirably include waterproof mechanisms. Consequently, even if dew condensation occurs in the heat absorber 51 and water drops adhere to the circulation fans 82, it is possible to suppress occurrence of an operation failure.

The cooling fans 83 are configured by, for example, axial fans or sirocco fans. In this embodiment, three cooling fans 83 are provided to correspond to the liquid crystal panels 451 functioning as the light modulating devices. When the projector 1 is set in the normal setting posture, the cooling fans 83 are located below the electrooptical device 45 in the lower duct 81B. Specifically, to set the rotation axes of the cooling fans 83, that is, a delivering direction of the cooling air along the third direction C3, the cooling fans 83 are disposed in positions where the cooling air circulates in the third direction C3. In other words, the cooling fans 83 are disposed to set the rotation axes of the fans substantially orthogonal to the bottom surface section 22 of the exterior housing 2. When the cooling fans 83 are driven by the control device, the cooling air delivered in the first direction C1 by the circulation fans 82 and circulating along the second direction C2 in the lower duct 81B is sucked and delivered toward the electrooptical device 45.

The air guide duct 84 guides the cooling air delivered from the cooling fans 83 respectively to the liquid crystal panels 451 corresponding to the cooling fans 83 among the three liquid crystal panels 451. Although not shown in the figure in detail, the air guide duct 84 delivers the cooling air, which is delivered from the cooling fans 83 and introduced into the inside, along the third direction C3 and guides the cooling air to the liquid crystal panels 451 corresponding to the cooling fans 83.

The partition wall 85 is provided between the air guide duct 84 and the electrooptical device 45. An opening (not shown in the figure) for ejecting the cooling air to the three liquid crystal panels 451 is provided in the partition wall 85.

Note that, when the sirocco fans are used as the cooling fans 83 as explained above, the air guide duct 84 is configured to enable the cooling air, which is delivered from the sirocco fans in a direction substantially orthogonal to the third direction C3, to circulate to the liquid crystal panels 451. Specifically, for example, the air guide duct 84 is formed in a shape extended in the direction substantially orthogonal to the third direction C3 and thereafter bent in the third direction C3.

In such a circulating and cooling device 8, the cooling air cooled by the heat absorption in the heat absorber 51 is delivered along the first direction C1 by the circulation fan 82 located on the end portion 81B2 side of the lower duct 81B. Thereafter, the cooling air circulates along the second direction C2 in the lower duct 81B. The cooling air is sucked by the cooling fans 83 located on the end portion 81B1 side of the lower duct 81B, delivered in the third direction C3 via the air guide duct 84, and circulated to the electrooptical device 45 located in the connecting section 81A. Consequently, the electrooptical device 45 is cooled.

The cooling air, which has cooled the electrooptical device 45, is fed into the upper duct 81C from the end portion 81C1. Thereafter, the cooling air circulates in the upper duct 81C along the fourth direction C4 and, after being sucked by the circulation fans 82, circulates along the first direction C1. At this point, the cooling air circulates along the heat absorber 51, whereby the heat of the cooling air is absorbed. Consequently, the cooling air is cooled. The cooling air is delivered along the first direction C1 again by the circulation fans 82.

In this way, the air in the closed housing 81 cools the electrooptical device 45 and is cooled by the heat absorber 51 in a process in which the air is annularly circulated.

### Disposition of the Heat Absorber and the Electrooptical Device

As explained above, the heat absorber 51 is disposed on the end portion 81B2 side in the lower duct 81B and in the part where the cooling air circulates along the first direction C1. The electrooptical device 45 is disposed on the end portion 81B1 side in the lower duct 81B and in the part where the cooling air circulates along the third direction C3. That is, the heat absorber 51 and the electrooptical device 45 are disposed apart from each other on one end side and the other end side of the lower duct 81B formed in the U shape in longitudinal sectional view in the closed housing 81. In other words, the heat absorber 51 and the electrooptical device 45 are disposed in positions on the opposite sides in the closed housing 81. More specifically, the heat absorber 51 and the electrooptical device 45 are located on opposite sides each other across the inner wall section 812 in the closed housing 81.

When the projector 1 is changed from the normal setting posture to the upward projection posture or the downward projection posture, the heat absorber 51 and the electrooptical device 45 are also located on the opposite sides each other across the inner wall section 812 in the closed housing 81.

That is, the electrooptical device 45 and the heat absorber 51 are disposed apart from each other across the inner wall section 812 in a direction from the left side surface section 25 toward the right side surface section 26 (the horizontal direction during the normal setting posture). In such a configuration, even when the projector 1 is changed from the normal setting posture to the upward projection posture or the downward projection posture, the electrooptical device 45 and the heat absorber 51 are always disposed apart from each other in the horizontal direction.

Further, when the projector 1 is disposed in the normal setting posture, the heat absorber 51 and the electrooptical device 45 are disposed apart from each other along the horizontal direction. When the projector 1 is disposed in the lateral setting posture, the heat absorber 51 is disposed to be located further on the vertical direction lower side than the electrooptical device 45.

Since the heat absorber 51 and the electrooptical device 45 are disposed in this way, even when the heat absorber 51 is cooled and dew condensation occurs in the heat absorber 51, it is possible to suppress water drops caused in the heat absorber 51 from adhering to the electrooptical device 45. This is not only because the distance between the heat absorber 51 and the electrooptical device 45 can be set relatively long but also because, since the inner wall section 812 is located between the heat absorber 51 and the electrooptical device 45, the inner wall section 812 can be used as an obstacle when the water drops flow along the inner wall section 812.

### Effects of the Embodiment

The projector 1 according to this embodiment explained above has effects explained below.

In the aspect explained above, the projector 1 includes the circulation fans 82 that circulate the cooling air along the circulation channel on the inside of the closed housing. The electrooptical device 45, which is the cooling target, and the heat absorber 51 are disposed on the opposite sides across the inner wall section 812. In such a configuration, the electrooptical device 45 and the heat absorber 51 can be disposed apart from each other in a state in which the electrooptical device 45 and the heat absorber 51 are partitioned by the inner wall section 812. Therefore, even if water drops due to dew condensation in the heat absorber 51 scatter, it is possible to block the water drops with the inner wall section 812 before the water drops adhere to the electrooptical device 45. It is possible to suppress the adhesion of the water drops to the electrooptical device 45.

The electrooptical device 45, which is the cooling target, includes electronic devices such as the liquid crystal panels 451. Therefore, for example, when the water drops caused by the dew condensation of the heat absorber 51 adhere exceeding an allowable degree (an amount or a frequency) assumed in advance, it is likely that deficiencies such as malfunction and performance deterioration of the electronic devices occur.

On the other hand, in the projector 1 according to this embodiment, as explained above, even if water drops scatter, the water drops can be blocked by the inner wall section 812. It is possible to suppress the water drops from adhering to the electrooptical device 45. Therefore, it is possible to suitably suppress the occurrence of the deficiencies such as the malfunction and the performance deterioration. It is possible to appropriately cool the cooling target.

The electrooptical device 45 and the heat absorber 51 are disposed via the upper duct 81C and the lower duct 81B. Consequently, it is possible to increase the distance between the electrooptical device 45 and the heat absorber 51. It is possible to more surely suppress deterioration in the performance of the cooling target due to the water drops.

The electrooptical device 45 and the heat absorber 51 are partitioned by the partition wall 85 of the air guide duct 84 and disposed on the opposite sides of the annular circulation channel. Consequently, even if water drops due to dew condensation in the heat absorber 51 scatter, it is possible to block the water drops with the partition wall 85 before the water drops adhere to the electrooptical device 45. Therefore, it is possible to more surely suppress the adhesion of the water drops.

The electrooptical device 45 and the heat absorber are disposed in the positions where the circulating direction of the cooling air is opposite directions in the circulation channel. In such a configuration, the electrooptical device 45 and the heat absorber 51 can be disposed in separated positions in the circulation channel. Consequently, it is possible to surely dispose the electrooptical device 45 and the heat absorber 51 on opposite sides each other in the circulation channel. It is possible to dispose the electrooptical device 45 and the heat absorber 51 apart from each other. Therefore, even when the water drops occur, it is possible to more surely suppress the water drops from adhering to the electrooptical device 45.

The projector 1 includes the circulation fans 82 and the cooling fans 83 on the circulation channel. The fans 82 and 83 are disposed on the circulation channel to circulate the cooling air in opposite directions each other. The cooling fans 83 circulate the cooling air to the electrooptical device 45 via the air guide duct 84.

In such a configuration, the electrooptical device 45 is located on the channel in which the cooling air circulates in the third direction C3. Therefore, the cooling fans 83 deliver the cooling air in the third direction C3 via the air guide duct 84. Consequently, it is possible to surely circulate the cooling air to the cooling target.

The fans 82 and 83 are respectively disposed to be opposed to each other in the electrooptical device 45 and the heat absorber 51 disposed on the opposite sides of the circulation channel. That is, the fans 82 and 83 are disposed in positions overlapping each other in plan view along the circulating direction of the cooling air in each of the heat absorber 51 and the electrooptical device 45. In such a configuration, even when the electrooptical device 45 and the heat absorber 51 are disposed apart from each other, it is possible to circulate the cooling air with the fans 82 and 83 and more surely circulate the cooling air to the heat absorber 51 and the electrooptical device 45.

The respective rotation axes of the circulation fans 82 and the cooling fans 83 are substantially orthogonal to the bottom surface section 22 (the top surface section 21) of the exterior housing 2.

When, to set the rotation axes along the second direction C2 and the fourth direction C4, the circulation fans 82 and the cooling fans 83 are disposed on a channel in which the cooling air circulates in the second direction C2 and the fourth direction C4, the dimensions of the closed housing 81 in directions orthogonal to the bottom surface section 22 (the top surface section 21) (i.e., the first direction C1 and the third direction C3) increase according to the dimensions of the fans.

On the other hand, to set the rotation axes to be substantially orthogonal to the bottom surface section 22 (the top surface section 21) of the exterior housing 2, the circulation fans 82 and the cooling fans 83 are respectively disposed in positions where the cooling air is delivered in the first direction C1 and the third direction C3. Consequently, it is possible to reduce the dimensions of the closed housing 81 in the first direction C1 and the third direction C3. Therefore, it is possible to achieve a reduction in the thickness of the projector 1.

The projector 1 includes the circulation fans 82 and the cooling fans 83 on the circulation channel. The fans 82 and 83 are disposed to circulate the cooling air in the opposite directions each other. Therefore, for example, compared with when the fans 82 and 83 are disposed to circulate the cooling air in orthogonal directions, it is possible to reduce the thickness dimension of the projector 1 and achieve a reduction in the thickness of the projector 1.

The heat absorber 51, the circulation fans 82, the cooling fans 83, and the electrooptical device 45, which is the cooling target, are sequentially disposed along the channel of the cooling air. In such a configuration, it is possible to circulate, with the circulation fans 82, the cooling air delivered to the electrooptical device 45 by the cooling fans 83 and heated and guide the cooling air to the heat absorber 51. It is possible to appropriately cool the cooling target.

The circulation fans 82 and the cooling fans 83 are disposed between the heat absorber 51 and the electrooptical device 45 in the circulation channel. Therefore, even if water drops due to dew condensation in the heat absorber 51 scatter, it is possible to stop the water drops with the circulation fans 82 and the cooling fans 83.

In the projector 1, the electrooptical device 45 and the heat absorber 51 are spaced apart in the direction along the horizontal direction during the setting in the normal setting posture (the first posture). In such a configuration, it is possible to suppress water drops from dropping from the heat absorber 51 and adhering to the electrooptical device 45. It is possible to suppress occurrence of a deficiency due to the adhesion of the water drops.

Further, in the projector 1, the heat absorber 51 is disposed below the electrooptical device 45 during the setting in the lateral setting posture (the second posture) in which the projector 1 is set to tilt with respect to the normal setting posture.

In such a configuration, irrespective of in which posture the projector 1 configured to be capable of being set in the normal setting posture and the lateral setting posture is disposed, it is possible to suppress water drops from dropping from the heat absorber 51 and adhering to the electrooptical device 45 and suppress occurrence of a deficiency due to the adhesion of the water drops.

In the projector 1, in a process in which the posture of the projector 1 is changed from any one of the upward projection posture (the third posture), the downward projection posture (the fourth posture), and the normal setting posture to another posture (e.g., from the normal setting posture to the upward projection posture or the downward projection posture), the electrooptical device 45 and the heat absorber 51 are always spaced apart from each other in a direction along the horizontal direction during the setting. In such a configuration, it is possible to suppress water drops from dropping from the heat absorber 51 and adhering to the electrooptical device 45 and suppress occurrence of a deficiency due to the adhesion of the water drops.

### Modifications of the Embodiment

The invention is not limited to the embodiment. Modifications, improvements, and the like within a range in which the object of the invention can be attained are included in the invention.

In the embodiment, the configuration is illustrated in which the heat absorbed by the heat absorbing device 5 is transferred or radiated to the outside using the heat exchanging device 6. However, the invention is not limited to this. That is, the heat absorbed from the heat absorber 51 only has to be capable of being radiated to the outside. For example, a heat radiating device configured to radiate the heat absorbed by the heat absorber 51 with a radiator or the like not via the heat exchanging device 6 may be adopted. The circulation pipes 543 and 544 may be connected to the heat radiating device to cool the heat absorber 51. Further, a heat radiating member such as a heat sink may be provided outside the closed housing 81. The heat radiating member and the heat absorber 51 may be connected to be capable of transferring heat. In this case, the heat radiating member and the heat absorber 51 may be connected by a thermoelectric conversion element such as a Peltier element or may be connected by a heat pipe.

In the embodiment, the electrooptical device 45 is illustrated as the cooling target. However, the invention is not limited to this. The devices 41 to 44 (e.g., the polarization converting element 424) configuring the optical unit 4 and the members configuring the projector 1 may be set as the cooling target. In this case as well, it is possible to suppress performance deterioration and malfunction due to adhesion of water drops and stably drive the projector.

In the embodiment, the configuration is illustrated in which the cooling fans 83 are disposed in the vicinity of the electrooptical device 45. However, the invention is not limited to this. For example, it is also possible to circulate the cooling air with the circulation fans 82 without providing the cooling fans 83.

In the embodiment, the configuration is illustrated in which the closed housing 81 includes the lower duct 81B and the upper duct 81C forming the annular circulation channel. However, the invention is not limited to this. The closed housing 81 is not particularly limited as long as the circulation channel can be formed on the inside. For example, the closed housing 81 may include a wall section in the center. The cooling target and the heat absorber 51 may be disposed apart from each other via the wall section. The circulation channel may be formed by disposing fans and the like on the inside of the closed housing 81 as appropriate.

In the embodiment, the configuration is illustrated in which the lower duct 81B and the upper duct 81C are formed in the substantially U shape in the closed housing 81. However, the invention is not limited to this. For example, the lower duct 81B and the upper duct 81C may be formed in a V shape.

In the embodiment, the electrooptical device 45 serving as the cooling target is cooled by the air. However, the invention is not limited to this. The electrooptical device 45 serving as the cooling target may be cooled by using gas more excellent in thermal conductivity than the air as a medium.

In the embodiment, the two circulation fans 82 and the three cooling fans 83 are provided. However, the invention is not limited to this. The setting numbers of circulation fans 82 and the cooling fans 83 may be changed as appropriate according to the ability of the heat absorber 51, the specifications of the fans, and the like.

In the embodiment, in the normal setting posture, the heat absorber 51 is disposed to be spaced apart from the electrooptical device 45 along the horizontal direction. In the lateral setting posture, the heat absorber 51 is disposed below the electrooptical device 45. However, the invention is not limited to this. That is, in the lateral setting posture, the electrooptical device 45 and the heat absorber 51 may be disposed to be spaced apart from each other along the horizontal direction.

In the embodiment, the projector 1 includes the three liquid crystal panels 451 as the light modulating devices. However, the invention is not limited to this. That is, the invention is also applicable to a projector including two or less or four or more liquid crystal panels.

In the embodiment, the disposing positions of the optical components in the optical unit 4 can be changed as appropriate. For example, configurations having a substantially I shape in plan view and configurations having a substantially U shape in plan view may be adopted.

In the embodiment, the transmissive liquid crystal panels 451 in which light beam incident surfaces and light beam emission surfaces are different are adopted. However, reflective liquid crystal panels in which light incident surfaces and light emission surfaces are the same may be adopted.

In the embodiment, the configuration is illustrated in which the liquid crystal panels are adopted as light modulators. However, light modulators of other configurations may be adopted as long as the light modulators can modulate an incident light beam according to a control signal (image information). For example, the invention is also applicable to a projector including light modulators other than liquid crystal such as devices including micro mirrors. When such light modulating devices are used, polarizing plates only have to be disposed as appropriate to set polarizing directions of modulated lights as appropriate.

### CROSS REFERENCE TO RELATED APPLICATIONS

This application claims priority to Japanese Patent Application No. 2015-079014 filed on Apr. 8, 2015, the entire contents of which are incorporated by reference herein.

What is claimed is:

1. A projector comprising a cooling device configured to cool a cooling target, wherein
the cooling device includes:
a closed housing in which the cooling target is disposed and a circulation channel for circulating cooling air is formed;
a circulation fan configured to circulate the cooling air in the closed housing; and
a heat absorber disposed on the circulation channel and configured to absorb heat of the cooling air in the closed housing,
the closed housing includes, on an inner side, an inner wall section that forms the circulation channel having an annular shape, and
the heat absorber is disposed on an opposite side of the cooling target across the inner wall section.

2. The projector according to claim 1, wherein the heat absorber is disposed on a channel of the cooling air circulating in a direction opposite to one direction, which is a circulating direction of the cooling air circulating to the cooling target in the circulation channel.

3. The projector according to claim 2, wherein
the cooling device includes a cooling fan and an air guide duct configured to circulate the cooling air in the closed housing to the cooling target,
the cooling fan delivers the cooling air in the one direction via the air guide duct, and
the circulation fan delivers the cooling air in the opposite direction.

4. The projector according to claim 3, further comprising an exterior housing configuring an exterior, wherein
respective rotation axes of the cooling fan and the circulation fan are substantially orthogonal to a bottom surface of the exterior housing.

5. The projector according to claim 3, wherein the cooling air circulates in order of the heat absorber, the circulation fan, the cooling fan, and the cooling target.

6. The projector according to claim 1, further comprising an exterior housing configuring an exterior, wherein
the cooling target and the heat absorber are disposed apart from each other in a horizontal direction when the projector is set in a first posture in which a bottom surface of the exterior housing is substantially horizontal, and
the heat absorber is located below the cooling target when the projector is set in a second posture in which one side surface of the exterior housing faces vertically downward.

7. The projector according to claim 6, wherein, when a posture of the projector is changed from the first posture to a third posture in which a rear surface of the exterior housing faces vertically downward or a fourth posture in which the rear surface faces vertically upward, the cooling target and the heat absorber are always disposed apart from each other in the horizontal direction during a process of the posture change.
